(19) United States
(12) Patent Application Publication
(10) Pub. No.: US 2024/0201638 A1
(43) Pub. Date: Jun. 20, 2024

(54) METHOD AND DEVICE WITH PROCESS DATA ANALYSIS

(71) Applicant: Samsung Electronics Co., Ltd., Suwon-si (KR)

(72) Inventors: Namyeong KWON, Suwon-si (KR); Inchul SONG, Suwon-si (KR)

(73) Assignee: Samsung Electronics Co., Ltd., Suwon-si (KR)

(21) Appl. No.: 18/330,692

(22) Filed: Jun. 7, 2023

(30) Foreign Application Priority Data
Dec. 20, 2022 (KR) 10-2022-0179589

(51) Int. Cl. G05B 13/02; G05B 13/04

(52) U.S. Cl. CPC G05B 13/0265; G05B 13/042

(57) ABSTRACT

A method and device with process attribution identification are provided. The method may include generating a process result using a first machine learning model provided input data, where the input data incudes feature values corresponding to a plurality of process features, generating sample data by a first modifying of at least a portion of reference data based on dependency between two or more of the plurality of process features, where the reference data includes a plurality of feature values for a reference process result, identifying an attribution of the plurality of process features based on the generated process result and a sample process result generated using the first machine learning model, or a second machine learning model related to the first machine learning model, provided the generated sample data.

### CROSS-REFERENCE TO RELATED APPLICATIONS

This application claims the benefit under 35 USC § 119(a) of Korean Patent Application No. 10-2022-0179589, filed on Dec. 20, 2022, in the Korean Intellectual Property Office, the entire disclosure of which is incorporated herein by reference for all purposes.

### BACKGROUND

### 1. Field

The following description relates to a method and device with process data analysis.

### 2. Description of Related Art

Among typical approaches of interpreting a model result, a representative approach is a Shapley value. When interpreting an output result of a model that receives data having multiple features, respective attribution values representing corresponding degrees of attribution of each of the multiple features to an output result of the model may be calculated. The Shapley value-based attribution analysis approach may be used in data of various domains and more particularly, may be used in the form of a table.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating a process result using a first machine learning model provided input data, where the input data incudes feature values corresponding to a plurality of process features, generating sample data by a first modifying of at least a portion of reference data based on dependency between two or more of the plurality of process features, where the reference data includes a plurality of feature values for a reference process result, identifying an attribution of the plurality of process features based on the generated process result and a sample process result generated using the first machine learning model, or a second machine learning model related to the first machine learning model, provided the generated sample data.

For the first modifying, the method may include modifying a first feature value of a first process feature of the reference data, and in response to a determination that a second process feature is dependent on the first process feature, may include selecting a second feature value of the second process feature from a candidate feature value that is dependent on the modified first feature value. The sample data may be based on the modified first feature value and the selected second feature value.

For the first modifying, the method may include modifying a first feature value of a first process feature, of the reference data, that is related to first equipment among pieces of the reference data, and may include modifying a second feature value of a second process feature, which may be related to at least one of a chamber or a reticle that are dependent on the first equipment, to be another feature value indicating at least one of a corresponding chamber and a corresponding reticle allocated to another equipment indicated by the modified first feature value. The sample data may be based on the modified first feature value and the modified second feature value.

For the first modifying, the method may include modifying a first feature value of a first process feature, of the reference data, that is related to a first operation stage among pieces of the reference data, and based on a result of a determination of whether a path, which includes the first operation stage, also includes a second operation stage being that the path also includes the second operation stage, may include generating the sample data corresponding to the path by modifying a second feature value of a second process feature that is related to the second operation stage.

The generating of the sample data by the first modifying of the at least portion of the reference data may include generating the sample data using a sample generation machine learning model.

The generating of the sample data may include generating a respective sample data for each of the plurality of process features.

The identifying of the attribution of the plurality of process features may include calculating confidence of respective sample data corresponding to each of the process features based on the generated sample process result, and may include identifying the attribution based on the calculated confidence.

The identifying of the attribution of the plurality of process features may include, when the sample process result is generated using the first machine learning model, generating another sample process result using the second machine learning model, when the sample process result is generated using the second machine learning model, generating the other sample process result using another second machine learning model, different from the second machine learning model, related to the first machine learning model, calculating confidence of respective sample data corresponding to each of the process features based on the generated sample process result and the generated other sample process result, and identifying the attribution based on the calculated confidence.

The method may further include generating another sample process result using the first machine learning model provided second modified sample data, where the second modified sample data may be obtained by performing a second modifying of the sample data that is different from the first modifying of the sample data, where the identifying of the attribution of the plurality of process features may include calculating a confidence of the sample data based on the sample process result and the other sample process result, and calculating an attribution of a process feature based on the calculated confidence.

The generating of the process result may include generating process results respectively using a plurality of different machine learning models provided the input data, and the identifying of the attribution of the plurality of process features may include respectively calculating attributions for a process feature, of the plurality of process features, based on the generated process results, identifying an attribution of the process feature based on the calculated attributions.

The method may further include, for the first input data and second input data, respectively of the input data, with a same feature value for a target process feature, identifying a representative attribution, as the identified attribution, of the target process feature based on a sum of a first attribution of the target process feature, which may be calculated based on the first input data, and a second attribution of the target process feature, which may be calculated based on the second input data.

The method may further include sorting at least one of the plurality of process features based on the identified attribution.

The method may further include adjusting at least one of the plurality of process features based on the identified attribution.

In one general aspect, examples include a non-transitory computer-readable storage medium storing instructions that, when executed by a processor, cause the processor to perform any one, any combination of, or all operations or methods described herein.

In one general aspect, an electronic device includes a processor configured to generate a process result using a first machine learning model provided input data, where the input data includes feature values corresponding to a plurality of process features, generate sample data by performance of a first modification of at least a portion of reference data based on dependency between two or more of the plurality of process features, where the reference data includes feature values that are considered when a reference process result is generated, and identify an attribution of the plurality of process features based on the generated process result and a sample process result generated using the first machine learning model, or a second machine learning model related to the first machine learning model, provided the generated sample data.

For the first modifying, the processor may be further configured to modify a first feature value of a first process feature of the reference data, and, in response to a determination that a second process feature is dependent on the first process feature, select a second feature value of the second process feature from a candidate feature value that is dependent on the modified first feature value. The sample data may be based on the modified first feature value and the selected second feature value.

For the first modifying, the processor may be further configured to modify a first feature value of a first process feature, of the reference data, that is related to first equipment among pieces of the reference data, and modify a second feature value of a second process feature, which may be related to at least one of a chamber or a reticle that are dependent on the first equipment, to be another feature value indicating at least one of a corresponding chamber and a corresponding reticle allocated to another equipment indicated by the modified first feature value. The sample data may be based on the modified first feature value and the modified second feature value.

For the first modifying, the processor may be further configured to modify a first feature value of a first process feature, of the reference data, that is related to a first operation stage among pieces of the reference data, and, based on a result of a determination of whether a path, which includes the first operation stage, also includes a second operation stage being that the path also includes the second operation stage, generate the sample data corresponding to the path by modifying a second feature value of a second process feature that is related to the second operation stage.

For the identifying of the attribution, the processor may be further configured to calculate confidence of respective sample data corresponding to each of the process features based on the generated sample process result, and identify the attribution based on the calculated confidence.

The processor may be further configured to adjust at least one of the plurality of process features based on the identified attribution.

In one general aspect, a processor-implemented method includes generating a process result using a first machine learning model provided input data, where the input data includes feature values corresponding to a plurality of process features, generating respective sample data using a sample generation machine learning model that is provided feature values of reference data, wherein the sample generation machine learning model generates the sample data that satisfies dependency between the plurality of process features, generating a sample process result using the first machine learning model, or a second machine learning model related to the first machine learning model, provided the generated sample data, and identifying at least one attribution of the plurality of process features based on the generated process result and the generated sample process result.

Other features and aspects will be apparent from the following detailed description, the drawings, and the claims.

### BRIEF DESCRIPTION OF THE DRAWINGS

FIG. 1 illustrates an example of operation of an electronic device, according to one or more embodiments.

FIG. 2 illustrates an example method of analyzing process data, according to one or more embodiments.

FIG. 3 illustrates example dependencies among a plurality of process features, according to one or more embodiments.

FIG. 4 illustrates an example identification of attribution of a process feature based on a confidence of sample data, according to one or more embodiments.

FIG. 5 illustrates an example operation of calculating a confidence of sample data based on modified sample data, according to one or more embodiments.

FIG. 6 illustrates an example operation of calculating a confidence of sample data using a machine learning model, according to one or more embodiments.

FIG. 7 illustrates an example operation of identifying attribution of a process feature using a plurality of machine learning models, according to one or more embodiments.

FIG. 8 illustrates an example identifying of a representative attribution of a target process feature using calculated attributions of the target process feature based on a plurality of pieces of input data including the same feature value as the target process feature, according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

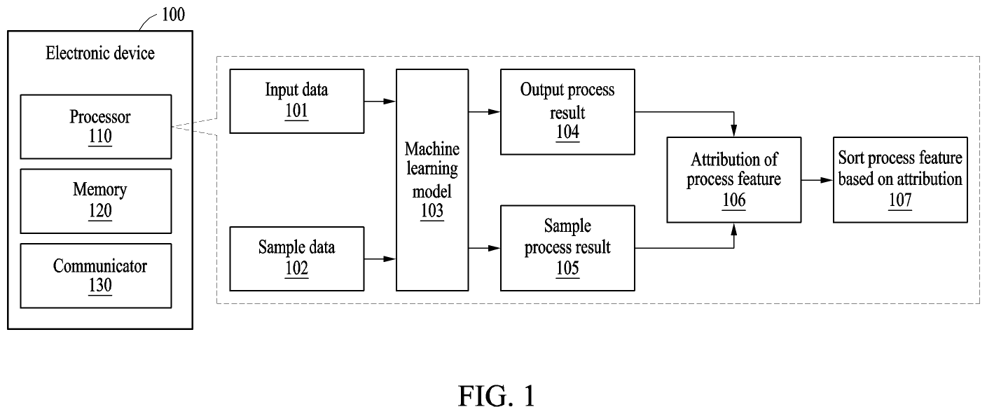

FIG. 1 illustrates an example operation of an electronic device, according one or more embodiments.

An electronic device 100 may analyze an output process result obtained by a target process. The target process may be at least a portion of a semiconductor process for fabrication of a device using a semiconductor and may refer to a process that is set to an analysis target of an electronic device. A semiconductor process may include, for example, any one or any combination of a wafer fabrication process, an oxidation process, a photo process, an etching process, a deposition process, a metallization process, an electrical test process, and a packaging process, as non-limiting examples.

The wafer fabrication process may include manufacturing a round pillar ingot by melting silicon, obtaining a wafer by cutting the ingot into thin slices, and fabricating a wafer processed through a surface polishing, as a non-limiting example. The oxidation process may include generating an oxide film on a wafer, where the oxide film may block a leakage current among circuits to be engraved on a wafer, as a non-limiting example. The photo process may refer to a process of drawing a circuit on the wafer using light. As a non-limiting example, the photo process may include applying photoresist on a wafer, covering the wafer with a reticle (also referred to as a “photomask”) corresponding to a circuit, and irradiating light to the wafer. The etching process may include removing at least a portion of an oxide film using an etchant, as a non-limiting example. The deposition process may be also referred to as an ion injection process and may include injecting ions into at least a portion of a silicon wafer, as a non-limiting example. The metallization process may include connecting a metal line for transmitting an electrical signal to operate a device, as a non-limiting example. The electrical test process may include testing an operation of a chip through an electrical inspection, as a non-limiting example. The packaging process may include packaging a chip, as a non-limiting example.

The target process may have a path including at least one path, as a non-limiting example. The target process may be specified by a process input and a process output and may have a plurality of paths having the same process input and the same process output. The path may include at least one operation stage for obtaining a process output from a process input. An operation stage may be a partial process of the target process and for example, may be defined based on the use of an independent component of the target process. For example, for a first partial process using equipment (e.g., equipment configured to perform a photo process) and a second partial process using a reticle allocated to the equipment, the first partial process and the second partial process may be defined as a first operation stage. A third partial process using another equipment (e.g., equipment configured to perform an etching process) performing another process and a fourth partial process using a chamber allocated to the other equipment may be defined as a second operation stage distinguished from the first operation stage. However, the definition of the operation stage based on the independent component is not limited thereto and an operation stage may be defined as a partial process using a plurality of independent components.

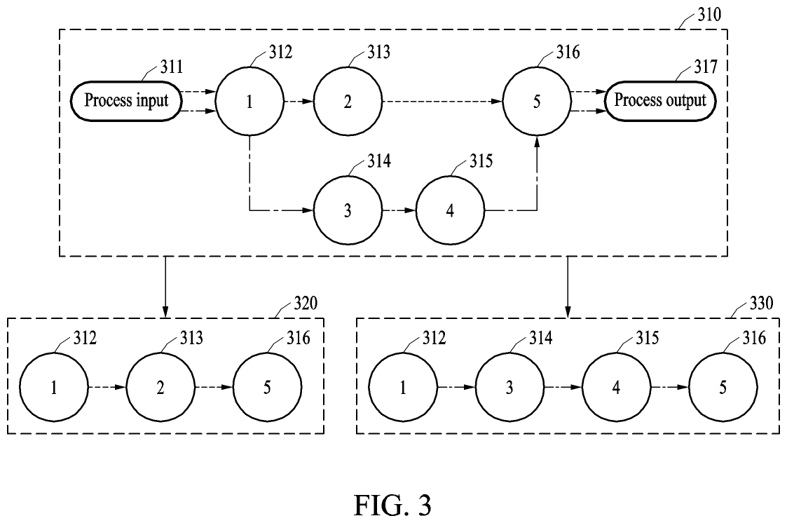

When the target process includes a plurality of paths, process data (e.g., input data, reference data, and sample data) may correspond to one of the plurality of paths. Generation of sample data based on a dependency on a path is described with reference to FIG. 3.

When the target process uses a first component (e.g., equipment) and a second component (e.g., a reticle or a chamber allocated to the equipment) dependent on the first component, sample data may be generated based on a dependency between a first process feature on the first component and a second process feature on the second component. Generation of sample data based on a dependency on a component allocated to equipment is described in greater detail below with reference to FIG. 3.

The electronic device 100 may identify an attribution 106 of a process feature indicating a degree of attribution of each process feature of input data 101 to an output process result 104. The electronic device 100 may obtain the output process result 104 by applying a machine learning model 103 to the input data 101. The electronic device 100 may identify the attribution 106 of the process feature using the machine learning model 103. Herein, “application of a machine learning model to data” may refer to performing an operation of the machine learning model using the data. For example, “applying a machine learning model to input data” may refer to performing an operation of the machine learning model based on values or other information of the input data that is input to the machine learning model. For example, if the input data is input to (e.g., provided or applied to) a neural network or a tree-based model, which are trained to generate an inferred result, the neural network and/or a tree-based model may output the inferred result using the input data. Said another way, an implementing of the neural network or the tree-based model provided input data, or an inputting of the input data to the neural network or the tree-based model, also results in the neural network generating the inferred result.

The input data 101 may be a piece of process data and may refer to process data that is a target of an attribution analysis for the output process result of the process feature. The process data may be respective data indicating information on a component (e.g., equipment, a chamber, a reticle, a temperature, a time, a recipe, a sensor, an optical critical dimension (OCD), an optical emission spectrometer (OES), a measurement image, a measurement value, and/or the like) of a target process and may include respective feature values of a plurality of process features for the target process. The process data may include, for example, input data that is an analysis target, reference data that is a reference for the analysis, and sample data used for the analysis. Herein, the process feature may represent an individual item and/or a category classifying information on the target process. For example, the process feature may include an equipment feature, a chamber feature, a reticle feature, and a recipe feature used in an operation stage included in the target process. Examples of input data and a process feature are described in greater detail below with reference to FIG. 3.

The output process result 104 may be information on a device processed through the target process and may include, for example, a yield, a value related to a change in states of a wafer before and after the target process, and the size of a structure, as non-limiting examples. The machine learning model 103 may be trained to output the output process result 104 corresponding to the input data 101 as the machine learning model 103 is applied to (or provided) the input data 101.

According to an example, the electronic device 100 may identify the attribution 106 of a process feature based on sample data 102 generated by modifying at least a portion of reference data.

The reference data may include feature values for a reference process result of a plurality of process features. For example, when the reference data is applied (or provided) to the machine learning model 103, the reference process result may be obtained. The reference process result may be a process result that is set to be a reference, and may be determined by, for example, an average (or a range of process results) of process results obtained from a process data set. The process data set may be a set of process data including respective feature values for a plurality of process features. For example, when the process result includes a yield, the reference data may correspond to a reference process result at an average yield and the input data 101 may correspond to the output process result 104 having a lower yield than the reference process result.

The sample data 102 may be respectively generated for each process feature of the input data 101. The sample data 102 respectively corresponding to each process feature may be used to determine a degree (e.g., an attribution of a process feature) of an influence of an example process feature of the input data 101 on the output process result 104. For example, the sample data 102 respectively corresponding to each process feature may include first sample data obtained by modifying a process feature of the reference data to have the same feature value as a corresponding process feature of the input data 101. The sample data 102 respectively corresponding to each process feature may include second sample data obtained by modifying an example process feature of the reference data to have a different value from a corresponding feature of the input data 101. However, examples are not limited thereto, and when the reference data has a different feature value from a corresponding process feature of the input data 101, the electronic device 100 may use the reference data as the second sample data. The electronic device 100 may calculate an attribution to the output process result 104 based on a feature value of a corresponding process feature being the same as the feature value of the input data 101, based on the first sample data and the second sample data.

According to an example, the electronic device 100 may obtain a sample process result 105 by applying the machine learning model 103 to the sample data 102. The electronic device 100 may identify the attribution 106 of a process feature based on the sample process result 105 and the output process result 104. For example, the electronic device 100 may generate the sample data 102 respectively corresponding to each process feature. The electronic device 100 may identify the attribution 106 of a corresponding process feature based on the output process result 104 and the sample process result 105 obtained from the sample data 102 corresponding to the process feature.

The electronic device 100 may sort at least some of the plurality of process features based on the identified attribution 106 of the process feature (e.g., based on an absolute value of the attribution 106). For example, by sorting the plurality of process features based on the respective identified attributions in descending order, the electronic device 100 may sort the process features in the order of having a greater influence on the output process result 104.

According to an example, the electronic device 100 may include a processor 110, a memory 120, and a communication device/system 130.

The processor 110 may be configured to obtain the output process result 104 by applying the machine learning model 103 to the input data 101, generate the sample data 102 from reference data, obtain the sample process result 105 by applying the machine learning model 103 to the sample data 102, and identify the attribution 106 of a process feature based on the output process result 104 and the sample process result 105. The processor 110 may be configured to execute computer-readable instructions.

The memory 120 may temporarily and/or permanently store at least one of the input data 101, the reference data, the sample data 102, the machine learning models described herein (e.g., including the machine learning model 103), the output process result 104, the sample process result 105, or the attribution 106 of the process feature. The memory 120 may store the computer-readable instructions, which when executed by the processor may configure the processor to perform one or more or any combination of operations or methods described herein. As a non-limiting example, the execution of the instructions may configure the processor to obtain the output process result 104, generate the sample data 102, obtain the sample process result 105, identify the attribution 106 of the process feature, and/or generate sorted process features 107. However, these are only examples, and information stored in the memory 120 is not limited thereto.

The communication device/system 130 may transmit or receive at least one of the input data 101 (e.g., using a transceiver represented by the communication device/system 130), the reference data, the sample data 102, the output process data 104, the sample process data 105, and the attribution 106 of the process feature. The communication device/system 130 may establish a wired communication channel and/or a wireless communication channel with an external apparatus (e.g., another electronic apparatus and a server), and may establish communication via a long-range communication network, such as cellular communication, short-range wireless communication, local area network (LAN) communication, Bluetooth™, wireless-fidelity (Wi-Fi), infrared data association (IrDA), a legacy cellular network, a fourth generation (4G) and/or 5G network, next-generation communication, the Internet, or a computer network (e.g., a LAN or a wide area network (WAN)), as non-limiting examples.

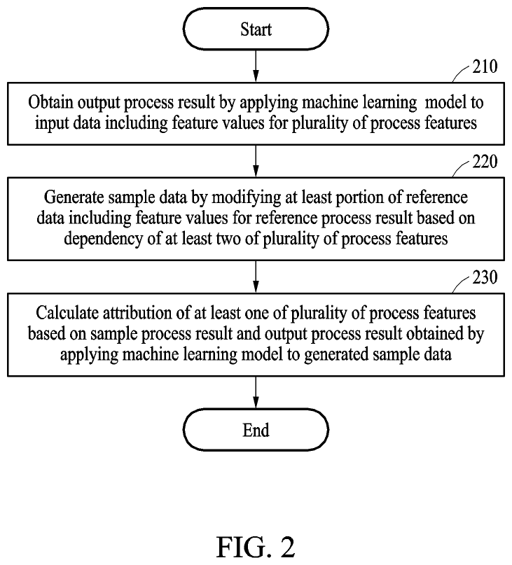

FIG. 2 illustrates an example method of analyzing process data, according to one or more embodiments.

An electronic device (e.g., the electronic device 100 of FIG. 1) in an example may be configured to, by applying a machine learning model to input data, obtain an output process result, generate sample data from reference data, and identify an attribution of a process feature based on a sample process result and the output process result.

In operation 210, the electronic device may obtain an output process result by applying a machine learning model to input data. The input data may include feature values for a plurality of process features. The input data may be data representing information on a target process and may represent an individual item and/or a category classifying information on the target process of the plurality of process features of the input data.

In operation 220, the electronic device may generate sample data by modifying at least a portion of reference data based on determined respective dependencies between at least two of the plurality of process features. The reference data may include feature values for a reference process result. The reference process result may refer to a process result that is set to be a comparison reference for the output process result. For example, when the input data corresponds to an output process result that is less than the reference process result, the electronic device may determine a process feature as having a great influence on a decrease in the output process result among the plurality of process features of the input data and/or may adjust the determined process feature to modify (e.g., to increase) the output process result to the reference process result.

However, the input data is not limited to corresponding to the output process result that is less than the reference process result and the input data may correspond to an output process result that is greater than the reference process result. For example, when the input data corresponds to an output process result that is greater than the reference process result, the electronic device may determine a process feature as having a great influence on an increase in the output process result among the plurality of process features of the input data. The electronic device may adjust the determined process feature to modify (e.g., to decrease) the output process result to the reference process result.

The electronic device in an example may modify at least a portion of the reference data based on respective dependencies between at least two of the plurality of process features.

The dependency between process features may represent that a feature value of a process feature is limited based on a feature value of another process feature. The dependency between process features may include dependency (e.g., dependency between an equipment feature and a chamber feature and dependency between an equipment feature and a reticle feature) related to a component allocated to equipment and dependency related to a path. For example, the second process feature may be dependent on the first process feature. The first process feature may have one of a first feature value and a second feature value and the second process feature may have one of a third feature value, a fourth feature value, a fifth feature value, and a sixth feature value. When the first process feature has the first feature value, the second process feature may be limited to have a feature value included in a first feature value set (e.g., a set including the third feature value and the fourth feature value). The first feature value set may be a partial set of all feature values (e.g., the third feature value, the fourth feature value, the fifth feature value, and the sixth feature value) available for the second process feature and may refer to a set of feature values (e.g., the third feature value and the fourth feature value) which may be possessed by the second process feature when the first process feature has the first feature value. When the first process feature has the second feature value, the second process feature may be limited to have a feature value included in a second feature value set (e.g., a set including the fifth feature value and the sixth feature value).

For example, the electronic device may modify the feature value of the first process feature of the reference data. In response to a case in which the second process feature is dependent on the first process feature, the electronic device may select a feature value of the second process feature from candidate feature values dependent on the modified feature value of the first process feature. For example, the electronic device may modify the first process feature of the reference data to have the first feature value. The electronic device may select a feature value of the second process feature of the reference data from candidate feature values (e.g., the third feature value and the fourth feature value) dependent on the first feature value of the first process feature. For example, the electronic device may modify the first process feature of the reference data to have the second feature value. The electronic device may select a feature value of the second process feature of the reference data from candidate feature values (e.g., the fifth feature value and the sixth feature value) dependent on the now (as modified) second feature value of the first process feature.

The electronic device in an example may generate sample data corresponding to each of the plurality of process features. For example, the electronic device may generate sample data for each process feature to calculate a corresponding attribution. The sample data corresponding to each process feature may be used to identify an attribution of the process feature of the input data. The electronic device may identify an attribution of a corresponding process feature based on a sample process result and an output process result obtained by applying a machine learning model to the sample data corresponding to each process feature.

The electronic device in an example may generate the sample data based on a sample generation model. As a non-limiting example the sample generation model may be machine learning model. The sample generation model may refer to a model that generates sample data satisfying dependency between process features. Satisfying dependency between process features may refer to a case in which the second process feature is dependent on the first process feature and a case in which the second feature has a feature value among candidate feature values dependent on the feature value of the first process feature. Violation of dependency between process features may refer to a case in which the second process feature is dependent on the first process feature and a case in which the second process feature has a feature value other than candidate feature values dependent on the feature value of the first process feature. For example, the sample generation model may include a model trained to output sample data as the sample generation model is applied to the reference data. The sample generation model may include a machine learning model trained to output sample data corresponding to a process feature as the sample generation model is applied to data (e.g., data indicating at least one process feature among the plurality of process features) on the process feature together with the reference data. For example, the sample generation model may be implemented by a neural network and/or a tree-based model.

In operation 230, the electronic device may identify an attribution of at least one of the plurality of process features, based on the sample process result and the output process result. The sample process result may be obtained by applying another machine learning model (e.g., the machine learning model 103 of FIG. 1) to the sample data. The output process result may be obtained by applying the other machine learning model to the input data.

The attribution of a particular process feature may refer to a degree that the particular process feature of the input data attributes to the obtained output process result of the machine learning model. The attribution of the process feature may refer to a degree that possession/inclusion of a predetermined feature value by the process feature attributes to the output process result. For example, the attribution of the process feature may be identified by quantifying the degree of influence that the process feature has a different feature value (e.g., of the reference data) on the output process result compared to that the process feature of the input data has a predetermined feature. For example, the attribution of the process feature may be identified by a Shapley value.

For example, the attribution of the process feature may be expressed based on the reference process result. For example, when the reference process result has an average yield and the first process feature of the input data, as attributed to the output process result, has a greater yield than the average yield, the attribution of the first process feature may be expressed as a positive number. When the second process feature of the input data, as attributed to the output process result, has a less yield than the average yield, the attribution of the second process feature may be expressed as a negative number.

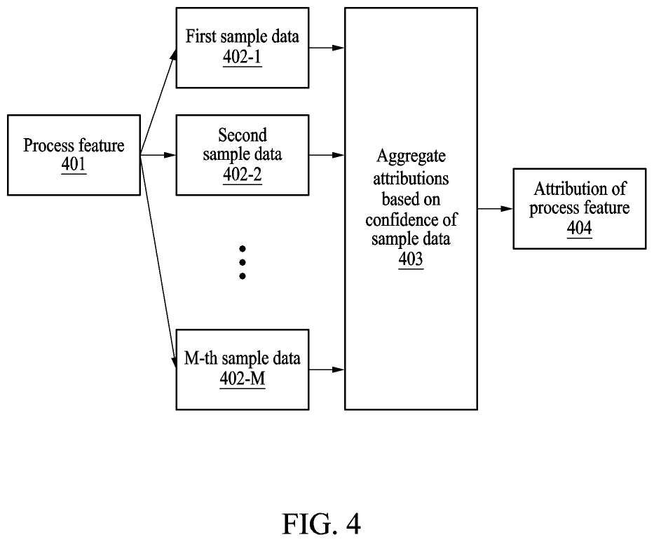

According to an example, the electronic device may identify the attribution of the process feature based on confidence of the sample data corresponding to the process feature. Identification of the attribution of the process feature based on confidence of the sample data is described in greater detail below with reference to FIGS. 4 to 6.

According to an example, the electronic device may sort at least some of the plurality of process features based on the identified attribution. For example, the electronic device may only indicate a highest attributing process feature distinguished from remaining process features, or may sort two or more process features based on their respective identified attributions. For example, by sorting the plurality of process features based on their respective identified attributions in descending order, the electronic device may sort the process features in the order of having a greater influence on an increase in the output process result. In another example, by sorting the plurality of process features in descending order based on absolute values of the respective identified attributions, the electronic device may sort the process features in order of having a greater influence on the output process result (e.g., an influence on an increase in the output process result or an influence on a decrease in the output process result).

The electronic device may adjust at least one of the plurality of process features based on the calculated attributions. The electronic device may adjust a process feature by modifying the process feature to have a different feature value. For example, the electronic device may modify the feature value of the process feature to another process feature value that is arbitrarily selected and allowed for the process feature or may modify the feature value of the process feature to a different feature value determined based on an attribution analysis using another input data.

Herein, adjustment of a process feature may include modifying a feature value of the process feature and modifying of a component for a target process based on modification of the feature value of the process feature. For example, when an equipment feature is adjusted by modifying a process feature (e.g., an equipment feature) corresponding to equipment from a first feature value indicating first equipment to a second feature value indicating second equipment, the equipment of the target process may be modified from the first equipment to the second equipment. The first equipment and the second equipment may refer to differentiated equipment that may perform the same operation, as a non-limiting example.

According to an example, the electronic device may adjust a process feature selected based on an absolute value of an attribution of the process feature. For example, when a yield of the output process result is less than a yield of the reference process result, the electronic device may determine a process feature that mostly attributes to the output process result to have a low yield and may adjust the determined process feature. The electronic device may determine a process feature having the greatest absolute value among process features having negative attributions and may adjust the determined process feature. In another example, when the size of a structure of the output process result is less than the size of a structure of the reference process result, the electronic device may determine a process feature that mostly attributes to the output process result to have a small structure and may adjust the determined process feature. The electronic device may determine a process feature having the greatest absolute value among process features having positive attributions and may adjust the determined process feature.

According to an example, the electronic device may adjust the process feature based on the identified attribution of the process feature using the plurality of pieces of input data. For example, the electronic device may identify an attribution of an equipment feature based on a first input data set and a second input data set. The first input data set may refer to a set of input data having the first feature value indicating the first equipment of the equipment feature. The second input data set may refer to a set of input data having the second feature value indicating the second equipment of the equipment feature. The electronic device may identify a first attribution of the equipment feature based on the first input data set and may identify a second attribution of the calculated equipment feature based on the second input data set. For example, the attribution of the process feature based on the input data set may be identified by calculating at least one of a sum, an average, and a distribution of identified attributions of process features from each piece of input data of the input data set. When the second attribution is greater than the first attribution, to increase the output process result, the electronic device may adjust the equipment feature by modifying the feature value of the equipment feature from the first feature value to the second feature value. The electronic device may modify the equipment of the target process from the first equipment to the second equipment.

FIG. 3 illustrates example dependencies among a plurality of process features, according to one or more embodiments.

An electronic device (e.g., the electronic device 100 of FIG. 1) in an example may generate sample data based on respective dependencies between at least two of a plurality of process features. A dependency between process features may include dependency on a path and dependency on a component allocated to equipment. Hereinafter, to describe the dependency on a path, a path included in a target process is described with reference to FIG. 3.

A target process 310 may be a process to obtain a process output 317 from a process input 311, and for example, as shown in FIG. 3, may include a first operation stage 312, a second operation stage 313, a third operation stage 314, a fourth operation stage 315, and a fifth operation stage 316.

By performing at least one of the plurality of operation stages included in the target process 310, the process output 317 may be obtained from the process input 311. The target process 310 may have a path including at least one operation stage that is performed to obtain the process output 317 from the process input 311. For example, by performing the first operation stage 312, the second operation stage 313, and the fifth operation stage 316 related to the process input 311, the process output 317 may be obtained and by performing the first operation stage 312, the second operation stage 313, the third operation stage 314, the fourth operation stage 315, and the fifth operation stage 316 related to the process input 311, the process output 317 may be obtained. The target process 310 may have a first path 320 including the first operation stage 312, the second operation stage 313, and the fifth operation stage 316. The target process 310 may have a second path 330 including the first operation stage 312, the third operation stage 314, the fourth operation stage 315, and the fifth operation stage 316.

The process data (e.g., input data, reference data, and sample data) may include a process feature related to each operation stage included in the target process 310. For example, the process data may have a process feature related to the first operation stage 312, a process feature related to the second operation stage 313, a process feature related to the third operation stage 314, a process feature related to the fourth operation stage 315, and a process feature related to the fifth operation stage 316.

Each piece of process data may correspond to at least one of the plurality of paths included in the target process 310. For example, first process data may correspond to the first path 320. Second process data may correspond to the second path 330.

In the process data, a process feature related to an operation stage included in a corresponding path may have a feature value indicating a component related to the operation stage. When a process feature related to an operation stage of the process data has a feature value indicating a component, it may represent that the operation stage is performed. In the process data, a process feature related to an operation stage that is different from an operation stage included in a corresponding path may have a feature value that does not indicate a component related to the operation stage. When a process feature related to an operation stage of the process data has a feature value that does not indicate a component, it may represent that the operation stage is not performed. A feature value that does not indicate a component related to an operation stage may have, for example, a feature value (e.g., a default value and a dummy value) indicating that an indicated component does not exist and/or a feature value (e.g., a feature value based on the process feature among the pieces of reference data) that is set to identify an attribution of the process feature to be 0. However, the example is not limited thereto, and the process feature related to another operation stage may not have a feature value.

The electronic device in an example may generate sample data by at least partially modifying the reference data based on the path.

The electronic device may modify a feature value of a target process feature (e.g., the first process feature) related to a target operation stage (e.g., the first operation stage). The electronic device may generate sample data corresponding to a path by modifying a feature value of another process feature (e.g., the second process feature) related to another operation stage (e.g., the second operation stage), based on whether the other operation stage (e.g., the second operation stage) is included in a path including the target operation stage (e.g., the first operation stage).

The sample data may correspond to at least one of the plurality of paths of the target process. The sample data may represent information on a process generated through the corresponding path. In the sample data, a process feature related to an operation stage included in a corresponding path may have a feature value for indicating a component related to the operation stage. In the sample data, a process feature included in an operation stage that is different from an operation stage included in a corresponding path may have a feature value that does not indicate a component related to the operation stage.

For example, when a different operation stage is included in a path including the target operation stage, the electronic device may modify a feature value of a process feature related to the different operation stage to a feature value indicating a component related to the different operation stage. When a different operation stage is not included in a path including the target operation stage, the electronic device may modify a feature value of a process feature related to the different operation stage to a feature value that does not indicate a component related to the different operation stage.

Referring to FIG. 3, for example, the electronic device may modify a feature value of a process feature related to the second operation stage 313 in the reference data. The feature value of the process feature related to the second operation stage 313 may be modified to a feature value indicating a component related to the second operation stage 313. The electronic device may modify a feature value of a different process feature based on the first path 320 including the second operation stage 313. The electronic device may modify a feature value of a process feature related to the different operation stage based on whether the different operation stage is included in the first path 320. For example, the electronic device may modify a feature value of a process feature related to the first operation stage 312 included in the first path 320 to a feature value indicating a component related to the first operation stage 312. The electronic device may modify a feature value of a process feature related to the fifth operation stage 316 included in the first path 320 to a feature value indicating a component related to the fifth operation stage 316. The electronic device may modify a feature value of a process feature related to the third operation stage 314 that is not included in the first path 320 to a feature value that does not indicate a component related to the third operation stage 314. The electronic device may modify a feature value of a process feature related to the fourth operation stage 315 that is not included in the first path 320 to a feature value that does not indicate a component related to the fourth operation stage 315. The electronic device may generate sample data corresponding to the first path 320 by modifying the reference data based on the first path 320.

However, dependency between process features is not limited to the dependency on a path and the dependency between process features may include dependency related to a component allocated to equipment. Hereinafter, dependency related to a component allocated to equipment is described.

The process data (e.g., input data, reference data, and sample data) may include a process feature related to each operation stage included in the target process 310. A process feature related to each operation stage may include a process feature corresponding to a component (e.g., equipment, a chamber, and a reticle) related to a corresponding operation stage of a target process. For example, when equipment and a chamber are used in each operation stage, the process data may include an equipment feature and a chamber feature related to the corresponding operation stage for each of the plurality of operation stages. As described above, the process data may correspond to at least one path and the process data may include a process feature related to an operation stage included in the corresponding operation stage and a process feature related to an operation stage (e.g., a different operation stage) that is not included in the path.

Dependency among process features related to the same operation stage may exist.

For example, when equipment and a chamber are used in an operation stage, the chamber may be selected from at least one chamber allocated to the equipment used in the same operation stage. A chamber feature related to the operation stage may be dependent on the equipment feature related to the same operation stage. The chamber feature related to the operation stage may have a feature value selected from candidate feature values determined based on a feature value of the equipment feature related to the same operation stage. In another example, when equipment and a reticle are used in an operation stage, the reticle may be selected from at least one reticle allocated to the equipment used in the same operation stage. The reticle feature related to the operation stage may be dependent on the reticle feature related to the same operation stage. The reticle feature related to the operation stage may have a feature value selected from candidate feature values determined based on a feature value of the equipment feature related to the same operation stage.

The electronic device in an example may generate sample data by partially modifying the reference data based on the dependency related to a component allocated the equipment.

The electronic device may modify a feature value of the first process feature (e.g., the equipment feature) related to equipment among the pieces of reference data. The electronic device may modify at least one feature value of the second process feature (e.g., the chamber feature and the reticle feature) among the chamber and the reticle dependent on the equipment. The electronic device may modify a feature value of the second process feature (e.g., the chamber feature and the reticle feature) to a feature value indicating at least one of the chamber and the reticle allocated to the equipment that is indicated by the modified feature value of the first process feature (e.g., the equipment feature).

For example, the electronic device may modify the feature value of the equipment feature related to the operation stage to a feature value indicating equipment A. The electronic device may modify the feature value of the chamber feature related to the same operation stage. The electronic device may modify the chamber feature related to the same operation stage to a feature value indicating at least one of chambers (e.g., a chamber A1, a chamber A2, and a chamber A3) allocated to the equipment A.

For example, the electronic device may modify the feature value of the equipment feature related to the operation stage to a feature value indicating equipment B. The electronic device may modify a feature value of the reticle feature related to the same operation stage. The electronic device may modify the reticle feature related to the same operation stage to a feature value indicating at least one of reticles (e.g., a reticle B1, a reticle B2, a reticle B3) allocated to the equipment B.

Table 1 shows examples of process data having a plurality of process features related to each operation stage.

TABLE 1

| | First | | Second | | Third | | Fourth | | Fifth | |
|---|---|---|---|---|---|---|---|---|---|---|
| | operation | | operation | | operation | | operation | | operation | |
| | stage | | stage | | stage | | stage | | stage | |
| | EQP_1 | CH_1 | EQP_2 | CH_2 | EQP_1 | CH_3 | EQP_4 | CH_4 | EQP_5 | CH_5 |
| D_1 | EQP_S1_A | CH_S1_A1 | EQP_S2_B | CH_S2_B1 | — | — | — | — | EQP_S5_C | CH_S5_C2 |
| D_2 | EQP_S1_D | CH_S1_D3 | — | — | EQP_S3_E | CH_S3_E1 | EQP_S4_F | CH_S4_F2 | EQP_S5_G | CH_S5_G1 |

In Table 1, process data (e.g., first process data D_1 and second process data D_2) may include a first equipment feature EQP_1 and a first chamber feature CH_1 related to the first operation stage 312, a second equipment feature EQP_2 and a second chamber feature CH_2 related to the second operation stage 313, a third equipment feature EQP_3 and a third chamber feature CH_3 related to the third operation stage 314, a fourth equipment feature EQP_4 and a fourth chamber feature CH_4 related to the fourth operation stage 315, and a fifth equipment feature EQP_5 and a fifth chamber feature CH_5 related to the fifth operation stage 316.

The first chamber feature CH_1 may be dependent on the first equipment feature EQP_1. The second chamber feature CH_2, the third chamber feature CH_3, the fourth chamber feature CH_4, and the fifth chamber feature CH_5 may be respectively dependent on the second equipment feature EQP_2, the third equipment feature EQP_3, the fourth equipment feature EQP_4, and the fifth equipment feature EQP_5.

The first process data D_1 may correspond to the first path 320. The first process data D_1 may include feature values indicating components of each operation stage related to the process features related to operation stages (e.g., the first operation stage 312, the second operation stage 313, and the fifth operation stage 316) included in the first path 320. The first process data D_1 may include feature values which do not indicate components of each operation stage related to process features related to operation stages (e.g., the third operation stage 314 and the fourth operation stage 315) which are not included in the first path 320. For reference, in Table 1, a feature value that does not indicate a component is expressed as a dash.

The first equipment feature EQP_1 and the first chamber feature CH_1 related to the first operation stage 312 of the first process data D_1 may respectively have a feature value EQP_S1_A and a feature value CH_S1_A1. The feature value EQP_S1_A may indicate the equipment A of the first operation stage 312. The feature value CH_S1_A1 may indicate the chamber A1 among the chambers A1, A2, and A3 allocated to the equipment A that is indicated by the feature value EQP_S1_A. The number of chambers (e.g., the chambers A1, A2, and A3) allocated to equipment (e.g., the equipment A) is only an example and is not limited thereto. A different number of chambers may be allocated to equipment.

The second equipment feature EQP_2 and the second chamber feature CH_2 related to the second operation stage 313 of the first process data D_1 may respectively have a feature value EQP_S2_B and a feature value CH_S2_B1. The feature value EQP_S2_B may indicate the equipment B of the second operation stage 313. The feature value CH_S2_B1 may indicate the chamber B1 among the chambers B1, B2, and B3 allocated to the equipment B that is indicated by the feature value EQP_S2_B.

The third equipment feature EQP_3 and the third chamber feature CH_3 related to the third operation stage 314 and the fourth equipment feature EQP_4 and the fourth chamber CH_4 related to the fourth operation stage 315 of the first process data D_1 may have feature values which do not indicate components.

The fifth equipment feature EQP_5 and the fifth chamber feature CH_5 related to the fifth operation stage 316 of the first process data D_1 may respectively have a feature value EQP_S5_C and a feature value CH_S5_C2. The feature value EQP_S5_C may indicate the equipment C of the fifth operation stage 316. The feature value CH_S5_C2 may indicate the chamber C2 among the chambers C1, C2, and C3 allocated to the equipment C that is indicated by the feature value EQP_S5_C.

The second process data D_2 may correspond to the second path 330. The second process data D_2 may include feature values indicating components for each operation stage for the process features related to operation stages (e.g., the first operation stage 312, the third operation stage 314, the fourth operation stage 315, and the fifth operation stage 316) included in the second path 330. The second process data D_2 may include feature values that do not indicate components for each operation stage related to the process features related to operation stages (e.g., the second operation stage 313) that is not included in the second path 330.

The first equipment feature EQP_1 and the first chamber feature CH_1 related to the first operation stage 312 of the second process data D_2 may respectively have a feature value EQP_S1_D and a feature value EQP_S1_D3. The feature value EQP_S1_D may indicate the equipment D of the first operation stage 312. The feature value CH_S1_D3 may indicate the chamber D3 among the chambers D1, D2, and D3 allocated to the equipment D that is indicated by the feature value EQP_S1_D.

The second equipment feature EQP_2 and the second chamber feature CH_2 related to the second operation stage 313 of the second process data D_2 may have feature values which do not indicate components.

The third equipment feature EQP_3 and the third chamber feature CH_3 related to the third operation stage 314 of the second process data D_2 may respectively have a feature value EQP_S3_E and a feature value EQP_S3_E1. The feature value EQP_S3_E may indicate the equipment E of the third operation stage 314. The feature value CH_S3_E1 may indicate the chamber E1 among the chambers E1, E2, and E3 allocated to the equipment E that is indicated by the feature value EQP_S3_E.

The fourth equipment feature EQP_4 and the fourth chamber feature CH_4 related to the fourth operation stage 315 of the second process data D_2 may respectively have a feature value EQP_S4_F and a feature value EQP_S4_F2. The feature value EQP_S4_F may indicate the equipment F of the fourth operation stage 315. The feature value CH_S4_F2 may indicate the chamber F2 among the chambers F1, F2, and F3 allocated to the equipment F that is indicated by the feature value EQP_S4_F.

The fifth equipment feature EQP_5 and the fifth chamber feature CH_5 related to the fifth operation stage 316 of the second process data D_2 may respectively have a feature value EQP_S5_G and a feature value EQP_S5_G2. The feature value EQP_S5_G may indicate the equipment G of the fifth operation stage 316. The feature value CH_S5_G2 may indicate the chamber G2 among the chambers G1, G2, and G3 allocated to the equipment G that is indicated by the feature value EQP_S5_G.

The electronic device in an example may generate sample data by at least partially modifying process data (e.g., reference data).

For example, the electronic device may modify the first equipment feature EQP_1 of the first process data D_1 to the feature value SQP_S1_D indicating the equipment D related to the first operation stage 312. The electronic device may modify the feature value of the first chamber feature CH_1 based on dependency between the first equipment feature EQP_1 and the first chamber feature CH_1. The electronic device may select a feature value of the first chamber feature CH_1 from a candidate feature value of the first chamber feature CH_1 dependent on the feature value EQP_S1_D of the first equipment feature EQP_1. The candidate feature value of the first chamber feature CH_1 may include feature values CH_S1_D1, CH_S1_D2, and CH_S1_D3 respectively indicating the chambers D1, D2, and D3 allocated to the equipment D that is indicated by the feature value EQP_S1_D. The electronic device may modify the feature value of the first chamber feature CH_1 to the feature value CH_S1_D2 that is selected from the candidate feature values of the first chamber feature CH_1.

For example, the electronic device may modify the feature value of the second equipment feature EQP_2 of the second process data D_2 to the feature value EQP_S1_B indicating the equipment B related to the second operation stage 313. As described above, the electronic device may modify the feature value of the second chamber feature CH_2 of the second process data D_2 based on dependency between the second equipment feature EQP_2 and the second chamber feature CH_2.

When a feature value of a process feature (e.g., the second equipment feature and the second chamber feature) related to the second operation stage is modified, the electronic device may generate process data (e.g., sample data) that corresponds to a path based on the first path including the second operation stage. The electronic device may modify a feature value of a process feature related to a different operation stage based on whether the different operation stage (e.g., the first operation stage 312, the third operation stage 314, the fourth operation stage 315, and the fifth operation stage 316) is included in the first path.

For example, when a different operation stage (e.g., the first operation stage 312 and the fifth operation stage 316) is included in the first path 320, the electronic device may modify a feature value of the process feature related to the different operation stage to a feature value indicating a component. For example, the electronic device may modify feature values of the first equipment feature EQP_1, the first chamber feature CH_1, the fifth equipment feature EQP_5, and the fifth chamber feature CH_5 to feature values indicating components. However, examples are not limited to the modification of a feature value of a process feature related to a different operation stage included in a path. For example, when the process feature related to the different operation stage already has a feature value indicating a component, the feature value may be maintained.

For example, when a different operation stage (e.g., the third operation stage 314 and the fourth operation stage 315) is not included in the first path 320, the electronic device may modify the feature value of the process feature related to the different operation stage to a feature value that does not indicate a component. For example, the electronic device may modify feature values of the third equipment feature EQP_3, the third chamber feature CH_3, the fourth equipment feature EQP_4, and the fourth chamber feature CH_4 to feature values which do not indicate components. However, examples are not limited to the modification of a feature value of a process feature related to a different operation stage that is not included in a path. For example, when a process feature related to the different operation stage already has a feature value that does not indicate a component, the feature value may be maintained.

FIG. 4 illustrates an example identification of attribution of a process feature based on a confidence of sample data, according to one or more embodiments.

An electronic device (e.g., the electronic device 100 of FIG. 1) in an example may identify an attribution of a process feature based on confidence of sample data of each process feature.

The electronic device may calculate confidence of sample data corresponding to each process feature. The electronic device may identify an attribution of a process feature from the sample data based on the calculated confidence of the sample data.

The confidence of the sample data may be confidence on a sample process result obtained by applying a machine learning model (e.g., the machine learning model 103 of FIG. 1) to the sample data and may represent prediction capability of the machine learning model for the sample data. The confidence of the sample data may represent certainty (or uncertainty) of the sample process result obtained by the machine learning model for the sample data. For example, when the machine learning model has a prediction capability that is less than a threshold (e.g., significantly low prediction capability) for generated sample data or uncertainty (e.g., significantly high uncertainty) exceeding a threshold, identification of an attribution of a process feature without referring to the confidence of the sample data may be inappropriate. According to an example, the electronic device may identify the attribution of the process feature by using the confidence of the sample data corresponding to each process feature as a weight.

According to an example, sample data corresponding to each process feature may include a sample data set including a plurality of pieces of sample data (e.g., first sample data 402-1, second sample data 402-2, . . . , and M-th sample data 402-M).

The electronic device may identify an attribution of a process feature based on confidence of the sample data set. The confidence of the sample data set may be calculated based on confidence of each piece of sample data of the sample data set. For example, the electronic device may calculate confidence of the sample data set and may identify an attribution of a process feature by multiplying the calculated confidence by a temporary attribution and a weight of the process feature. The temporary attribution may refer to an attribution of the process feature that is identified without referring to the confidence of the sample data.

The electronic device may identify an attribution of the process feature based on confidences of the plurality of pieces of sample data of the sample data set. In another example, the electronic device may calculate confidence of each piece of sample data (e.g., the first sample data 402-1, the second sample data 402-2, . . . , and the M-th sample data 402-M). The electronic device may identify the attribution of the process feature by a weighted sum of temporary attributions calculated from the sample data by using confidence of each piece of the sample data of the sample data set.

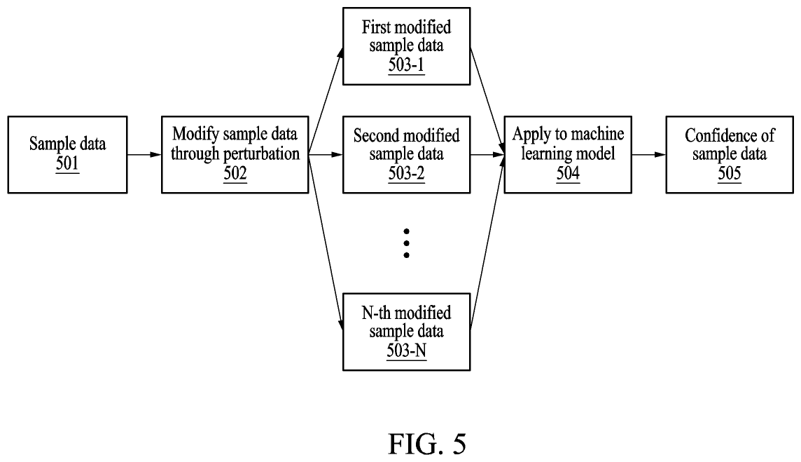

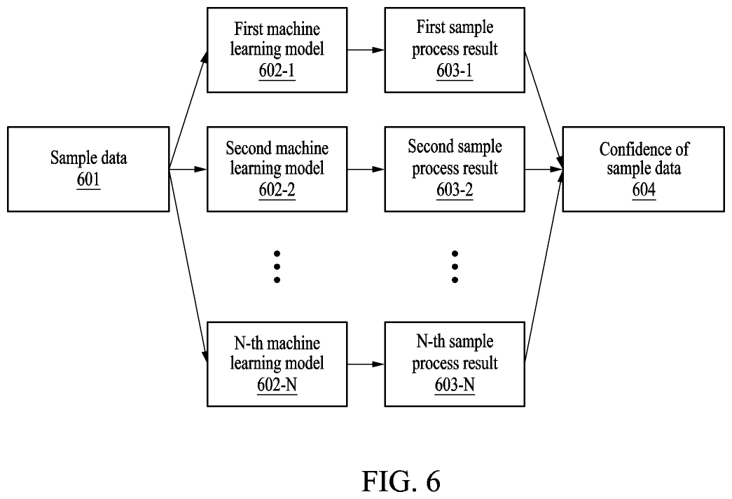

The confidence of the sample data of the sample data set may be calculated by another example machine learning model and/or modified sample data. Calculation of confidence of sample data using modified sample data is described in greater detail with reference to FIG. 5 and calculation of confidence of sample data using another machine learning model is described in greater detail with reference to FIG. 6.

FIG. 5 illustrates an example operation of calculating a confidence of sample data based on modified sample data, according to one or more embodiments.

An electronic device (e.g., the electronic device 100 of FIG. 1) in an example may calculate confidence of sample data using modified sample data (e.g., first modified sample data 503-1, second modified sample data 503-2, . . . , and N-th modified sample data 503-N) from sample data 501.

The electronic device may identify an attribution of a process based on the calculated confidence of sample data using a different sample process result. The different sample process result may be obtained by applying a machine learning model to modified sample data from the sample data.

In operation 502, the electronic device may obtain modified sample data (e.g., the first modified sample data 503-1, the second modified sample data 503-2, . . . , and the N-th modified sample data 503-N) from the sample data 501.

For example, the electronic device may obtain modified sample data by applying perturbation to the sample data 501. Applying perturbation to the sample data 501 may refer to applying a change that is less than or equal to a threshold to at least some of the process features of the sample data. For example, when a process has a numerical feature value, a change that is less than or equal to a threshold may represent that the feature value of the process feature changes (e.g., increase or decrease) by a change amount that is less than or equal to a threshold feature value. The threshold feature value may be predetermined or may be obtained by multiplying a predetermined threshold rate by the feature value of the process feature. For reference, when the process feature is related to a categorical component, the process feature may have a numerical feature value based on the categorical component. For example, the chamber feature may have a feature value of vector embedding calculated from data corresponding to the chamber A1. The feature value of vector embedding based on the chamber A1 may indicate the chamber A1.

In operation 504, the electronic device may obtain a different sample process result by applying a machine learning model to the modified sample data. The electronic device may calculate confidence 505 of the sample data based on the sample process result or at least one of different sample process results. For example, the electronic device may calculate the confidence 505 of the sample data based on a difference between the sample process result and different sample process results. For example, the electronic device may calculate the confidence 505 of the sample data that is inversely proportional to the difference between the sample process result and different sample process results.

When a difference between the sample process result and a different sample process result is great even if modified sample data is generated by applying a change that is less than or equal to a threshold to the sample data, the electronic device in an example may determine confidence of the sample data to be a less value compared to a case in which the difference is small. When a difference between the sample process result and the different sample process result is small, the electronic device may determine the confidence of the sample data to be a greater value compared to a case in which the difference is great.

According to an example, the electronic device may obtain a plurality of different sample process results by applying a plurality of pieces of sample data (e.g., the first modified sample data 503-1, the second modified sample data 503-2, . . . , and the N-th modified sample data 503-N) to a machine learning model. For example, the electronic device may calculate the confidence 505 of the sample data based on at least one distribution (e.g., a variance of a distribution) of the sample process result or the different sample process result. For example, the electronic device may calculate confidence of sample data based on a distribution of different sample process results. For example, the electronic device may calculate confidence of sample data based on a distribution of differences between the sample process result and the different sample process result.

FIG. 6 illustrates an example operation of calculating a confidence of sample data based on a machine learning model, according to one or more embodiments.

An electronic device (e.g., the electronic device 100 of FIG. 1) in an example may calculate confidence 604 of sample data using a different machine learning model (e.g., a first different machine learning model 602-1, a second different machine learning model 602-2, . . . , and an N-th different machine learning model 602-N).

The electronic device may identify an attribution of a process feature based on the calculated confidence of the sample data using the different sample process result (e.g., a first different sample process result 603-1, a second different sample process result 603-2, . . . , and an N-th different sample process result 603-N). The different sample process result may be obtained by applying a different machine learning model that is different from the machine learning model to the sample data.

The electronic device may obtain a different machine learning model modified from the machine learning model.

According to an example, the different machine learning model may be obtained by applying perturbation to the machine learning model. Applying perturbation to the machine learning model may refer to applying respective changes that are less than or equal to a threshold to at least a portion of parameters of the machine learning model. For example, the change that is less than or equal to a threshold may refer to a change (e.g., increase or decrease) in a parameter value of a parameter of the machine learning model by a change amount less than or equal to the threshold. The threshold may be predetermined or may be obtained by multiplying a parameter value by a predetermined threshold ratio.

For example, when the machine learning model is implemented as a neural network, the electronic device may obtain the different machine learning model by modifying respective weights of connection lines between at least some nodes to be less than or equal to the threshold. For example, when the machine learning model is implemented as a tree-based model, the electronic device may obtain the different machine learning model by modifying respective parameter values of some parameters (e.g., a probability) related to branching to be less than or equal to the threshold.

According to an example, the different machine learning models may include a first machine learning model that was trained from a first seed (e.g., first parameter values) and one or more other machine learning models that were respectively trained from respectively different other seeds (e.g., respective other parameter values) that are different from each other and the first seed. A seed may refer to parameter values that are set or initialized to initial parameter values prior to a training operation, as a non-limiting example. While the respective parameter value seeds may be different preset parameter values or initialized parameter values (e.g., randomized using random values, depending on the task, and/or the architecture of the model), the seeds may also be respective pre-trained parameter values, e.g., based on a preliminary training operation using limited training data, or other approaches to generate parameter values that are otherwise set to provide an initial guidance to the training operation that may speed convergence, as non-limiting examples.

According to an example, the different machine learning model may also or alternatively be a model trained by using a training data set that is different from the machine learning model. For example, the first machine learning model may be trained based on a first training data set and may be validated based on a first validation data set. The different one or more other machine learning models may each be trained based on respective other training data sets that are at least partially different from each other and from the first training data set, and may be validated based on respective other validation data sets that are different from each other and the first validation data set. The first training set and the first validation data set may be extracted from a training data set. The respective one or more other training data sets and the respective other validation data sets may be extracted from a data set that is the same as the data set from which the first training data set and the first validation data set are extracted. The first machine learning model and the one or more other machine learning models may also each be trained using different training data respectively extracted from different training data sets. Still further, the first machine learning model and the one or more other machine learning models may result from different ordering of training data to respectively train the first machine learning model and the one or more other second machine learning models. However, examples are not limited thereto.

The electronic device may obtain a different sample process result by applying the different machine learning model to sample data 601. The electronic device may calculate confidence 604 of the sample data based on the sample process result or at least one of different sample process results, respectively generated by different machine learning models. For example, the electronic device may calculate the confidence 604 of the sample data 601 based on a difference between the first sample process result (e.g., first sample result 603-1) and one or more different other sample process results (e.g., second sample process result 603-2 through 603-N). For example, the electronic device may calculate the confidence 604 of the sample data 601 that may be inversely proportional to the difference between the first sample process result and at least one of the different other sample process results.

When a difference between the first sample process result and the at least one different other sample process result is determined great even if a different machine learning model that generated the different other sample process results is generated by applying a change (i.e., compared to the first machine learning model that generated the first sample process result, or compared to another machine learning model that was changed to generate the first machine learning model) that is less than or equal to a threshold to the first or other machine learning model, the electronic device in an example may determine confidence of the sample data to be a lesser value compared to a case in which the difference is determined small. When a difference between the first sample process result and the at least one different other sample process result is determined small, the electronic device may determine the confidence of the sample data to be a greater value compared to a case in which the difference is determined great.

According to an example, the electronic device may obtain a plurality of different sample process results (e.g., a first different sample process result 603-1, a second different sample process result 603-2, . . . , and a N-th different sample process result 603-N) by respectively applying a plurality of different machine learning models (e.g., a first different machine learning model 602-1, a second different machine learning model 602-2, . . . , and a N-th different machine learning model 602-N) to the sample data 601. For example, the electronic device may calculate the confidence 604 of the sample data 601 based on at least one distribution (e.g., a variance of a distribution) of at least one of the different sample process results. For example, the electronic device may calculate confidence of sample data based on a distribution of different sample process results. For example, the electronic device may calculate confidence of sample data based on a distribution of differences between the different sample process results.

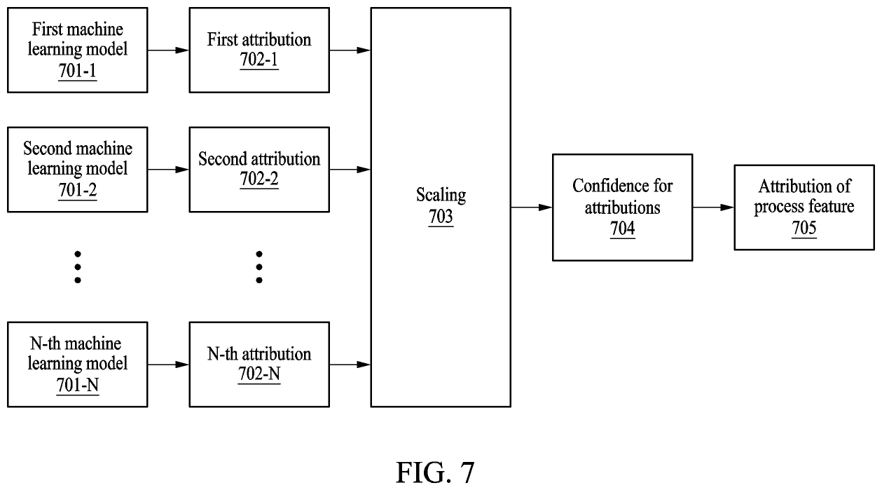

FIG. 7 illustrates an example operation of identifying attribution of a process feature using a plurality of machine learning models, according to one or more embodiments.

An electronic device (e.g., the electronic device 100 of FIG. 1) in an example may identify an attribution of a process feature using a plurality of machine learning models (e.g., a first machine learning model 701-1, a second machine learning model 701-2, . . . , and a N-th machine learning model 701-N). The plurality of machine learning models may output respective output process results by being applied to input data.

The plurality of machine learning models may be different machine learning models.

For example, the first machine learning model 701-1 may be a model implemented as a neural network and the second machine learning model 701-2 may be a model implemented as a tree-based model.

For example, when the first machine learning model 701-1 and the second machine learning model 701-2 are models implemented in a neural network (or a tree-based model), detailed implemented configurations (e.g., the number of layers and the number of nodes) of the first machine learning model 701-1 and the second machine learning model 701-2 may be different, e.g., the hyperparameters and/or architecture of the first machine learning model 701-1 may be different from the hyperparameters and/or architecture of the second machine learning model 701-2.

For example, the first machine learning model 701-1 and the second machine learning model 701-2 may generate respective output process results that are different from each other due to the differences between the first machine learning model 701-1 and the second machine learning model 701-2. In an example, the first machine learning model 701-1 may generate a first output process result including a yield and the second machine learning model 701-2 may generate a second output process result including a size of a structure.

For example, the first machine learning model 701-1 and the second machine learning model 701-2 may be differently trained, e.g., for different tasks. The first machine learning model 701-1 and the second machine learning model 701-2 may be trained through different trainings having different detailed configurations (e.g., an objective function, a training data set, a trained method (such as through supervised learning versus through unsupervised learning)) related to training.

For each of the plurality of machine learning models, the electronic device may calculate respective attributions (e.g., a first attribution 702-1 corresponding to the use of the first machine learning model 701-1, a second attribution 702-2 corresponding to the use of the second machine learning model 701-2, . . . , a N-th attribution 702-N corresponding to the use of the Nth machine learning model 701-N) of a process feature. The electronic device may identify an attribution 705 of the process feature based on the respective attributions (e.g., the first attribution 702-1, the second attribution 702-2, . . . , the N-th attribution 702-N). For example, the electronic device may identify the attribution 705 of the process feature based on an average, a sum, or a distribution of the respective attributions.

According to an example, the electronic device may perform scaling 703 on the respective attributions of the process feature. The respective attributions of the process feature may have different respective scales, e.g., due to the differences between the plurality of machine learning models. Due to the respective output process results including different information of the plurality of machine learning models and/or different prediction capabilities of the plurality of machine learning models, the respective attributions may have such different scales. Accordingly, based on such differences between scales of two or more of the plurality of machine learning models electronic device may scale one or more of the respective attributions of the process feature and may identify the attribution 705 of the process feature based on the one or more scaled attributions along with any remaining attributions among the respective attributions.

According to an example, the electronic device may identify the attribution 705 of the process feature using the confidence 704 for the respective attributions of the process feature based on the plurality of machine learning models. The electronic device may use the confidence 704 of the respective attributions as a weight of the attribution 705 of the process feature.

The electronic device may calculate the confidence of the respective attributions of the process feature and may identify the attribution 705 of the process feature by multiplying the calculated confidence by a temporary attribution of the process feature. The temporary attribution may refer to a calculated attribution of a process feature that is not based on the confidence of the respective attributions.

For example, the electronic device may calculate the confidence 704 based on a distribution (e.g., a variance of a distribution) of the respective attributions (e.g., the first attribution 702-1, the second attribution 702-2, . . . , the N-th attribution 702-N) of the process feature. When a difference among the respective attributions of the process feature is determined great, the electronic device may determine the confidence 704 of the respective attributions to be less than a case in which the difference is determined small. When a difference among the respective attributions of the process feature is determined small, the electronic device may determine the confidence 704 of the respective attributions to be greater than a case in which the difference is determined great.

For example, based on performance of each of the plurality of machine learning models, the electronic device may calculate the confidence 704 of the respective attributions based on each corresponding machine learning model. Based on the performance of each machine learning model (e.g., the first machine learning model 701-1, the second machine learning model 701-2, . . . the N-th machine learning model 701-N), the electronic device may calculate respective confidences of the respective attributions (e.g., the first attribution 702-1, the second attribution 702-2, . . . N-th attribution 702-N) based on a corresponding machine learning model (e.g., the first machine learning model 701-1 corresponding to the first attribution 702-1, the second machine learning model 701-2 the second attribution 702-2, . . . the N-th machine learning model 701-N corresponding to the N-th attribution 702-N). The electronic device may identify the attribution 705 of the process feature by using the respective confidences of the respective attributions as weights. For example, a greater weight may be assigned to the second attribution 702-2 based on the second machine learning model 701-2 having a second performance that is better than a first performance of the first machine learning model 701-1, so the second attribution 702-2 is emphasized more than the first attribution 702-1. The electronic device may similarly selectively emphasize and/or deemphasize some or all of the respective attributions, e.g., with respective emphasizing or deemphasizing weightings or no weightings, depending on the corresponding machine learning models' performances.

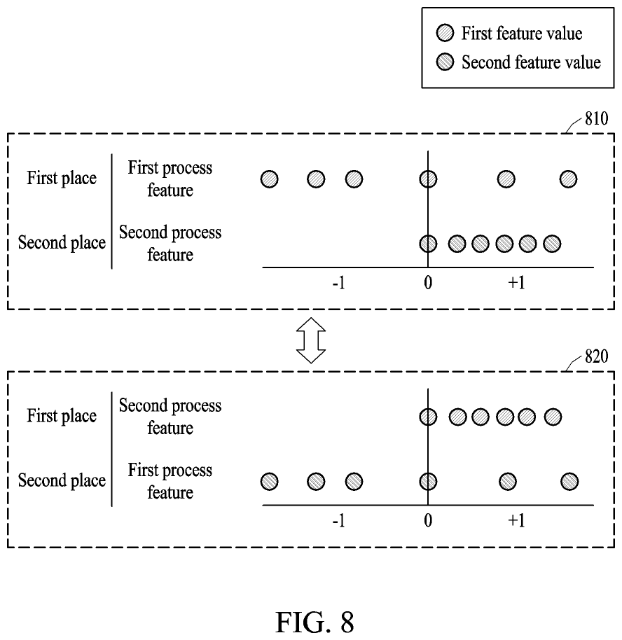

FIG. 8 illustrates an example identifying of representative attribution of a target process feature using respective attributions of the target process feature based on a plurality of pieces of input data including the same feature value as the target process feature, according to one or more embodiments.

An electronic device (e.g., the electronic device 100 of FIG. 1) in an example may identify a representative attribution of a target process feature based on a plurality of pieces of input data including a same feature value for the target process feature. The representative attribution may refer to a representative value of the respective attributions based on the plurality of pieces of input data having the same feature value for the target process feature.

According to an example, the electronic device may identify the representative attribution of the target process feature based on a sum of absolute values of a plurality of respectively calculated attributions of the target process feature based on the plurality of pieces of input data. When dispersion of the respectively calculated attributions of the target process feature is predetermined or determined important, the electronic device may identify the representative attribution of the target process feature based on the plurality of pieces of input data based on a sum of absolute values of the respectively calculated attributions. The electronic device may identify the representative attribution of the target process feature based on a degree of an influence in the case (e.g., in the case in which a calculated attribution is a positive number) in which the input data having the same feature value for the target process feature has an influence on an increase in the output process result and in the case (e.g., in the case in which the calculated attribution is a negative number) in which input data having the same feature value for the target process feature has an influence on a decrease in the output process result. The electronic device may identify the representative attribution of the target process feature based on the degree of the influence of the target process feature on the output process feature and for example, even if the plurality of pieces of input data have influences on the output process result in different directions (e.g., increase and decrease), the representative attribution of the target process feature may be identified such that the respectively calculated attributions do not offset each other even if the respectively calculated attributions have different signs.

Referring to FIG. 8, a graph 810 illustrates respective first attributions of the first process feature and a graph 820 illustrates respective second attributions of the second process feature, based on the plurality of pieces of input data. The plurality of pieces of input data may have a first feature value for the first process feature and a second feature value for the second process feature. In the graphs 810 and 820, the respective first attributions of the first process feature and the respective second attributions of the second process feature, with each attribution of graph 810 and graph 820 being respectively based on different pieces of input data, are represented by circles. The electronic device may identify a representative attribution of the first process feature based on a sum of absolute values of the respective first attributions of the first process feature. The electronic device may identify a representative attribution of the second process feature based on a sum of absolute values of the respective second attributions of the second process feature. When the first process feature has an influence on both an increase and a decrease in the output process result, for example, when respective first attributions having different signs are calculated, the electronic device may identify the representative attribution of the target process feature based on a sum of absolute values of the respective first attributions such that the respective first attributions with different signs do not offset each other. The electronic device may identify the representative attribution of the first process feature to be a greater value than the representative attribution of the second process feature. In the graph 810, for the representative attribution, the first process feature and the second process feature may be sorted in descending order.

According to an example, the electronic device may identify the attribution of the target process feature based on a sum of a plurality of calculated respective attributions, of the target process feature, respectively based on different pieces of input data.

For example, the electronic device may identify the attribution of the target process feature based on a sum of a first attribution and a second attribution. The first attribution may refer to a first calculated attribution of the target process feature based on the first input data. The second attribution may refer a calculated second attribution of the target process feature based on the second input data. The first input data and the second input data may include the same feature value for the target process feature.

The electronic device may identify the attribution of the target process feature based on a degree of an influence and a direction of the influence (e.g., increase or decrease) in the case (e.g., in the case in which a calculated respective attribution is a positive number) in which the input data having the same feature value for the target process feature has an influence on an increase in the corresponding output process result or in the case (e.g., in the case in which the calculated attribution is a negative number) in which input data having the same feature value for the target process feature has an influence on a decrease in the corresponding output process result. When a first input data and a second input data having the same feature value for the target process feature has an influence on changes (e.g., increase and decrease) in different directions of the corresponding output process result in the plurality of pieces of input data, for example, when respective attributions with different signs are calculated, the electronic device may identify the attribution of the target process feature based on a sum of the calculated respective attributions. The electronic device may identify the attribution of the target process feature of which the calculated respective attributions having different signs offset each other.

Referring to FIG. 8, the graph 820 illustrates calculated respective attributions of the first process feature and calculated respective attributions of the second process feature based on the plurality of pieces of input data. The electronic device may identify the representative attribution of the first process feature based on a sum of the calculated respective attributions of the first process feature. The electronic device may identify the representative attribution of the second process feature based on a sum of the calculated respective attributions of the second process feature. When the first process feature has an influence on both an increase and a decrease in the output process result, for example, when the respective attributions having different signs are calculated, the electronic device may identify the representative attribution of the target process feature based on a sum of the calculated respective attributions such that the calculated respective attributions offset each other. The electronic device may identify the representative attribution of the second process feature to be a greater value than the representative attribution of the first process feature. In the graph 820, for the representative attribution, the second process feature and the first process feature may be sorted in descending order.

The electronic devices, processors, memories, and communication device/system described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a process result using a first machine learning model provided input data, where the input data comprises feature values corresponding to a plurality of process features;
generating sample data by a first modifying of at least a portion of reference data based on dependency between two or more of the plurality of process features, where the reference data comprises a plurality of feature values for a reference process result; and
identifying an attribution of the plurality of process features based on the generated process result and a sample process result generated using the first machine learning model, or a second machine learning model related to the first machine learning model, provided the generated sample data.

2. The method of claim 1, wherein the first modifying comprises:
modifying a first feature value of a first process feature of the reference data; and
in response to a determination that a second process feature is dependent on the first process feature, selecting a second feature value of the second process feature from a candidate feature value that is dependent on the modified first feature value,
wherein the sample data is based on the modified first feature value and the selected second feature value.

3. The method of claim 1, wherein the first modifying comprises:
modifying a first feature value of a first process feature, of the reference data, that is related to first equipment among pieces of the reference data; and
modifying a second feature value of a second process feature, which is related to at least one of a chamber or a reticle that are dependent on the first equipment, to be another feature value indicating at least one of a corresponding chamber and a corresponding reticle allocated to another equipment indicated by the modified first feature value,
wherein the sample data is based on the modified first feature value and the modified second feature value.

4. The method of claim 1, wherein the first modifying comprises:
modifying a first feature value of a first process feature, of the reference data, that is related to a first operation stage among pieces of the reference data; and
based on a result of a determination of whether a path, which includes the first operation stage, also includes a second operation stage being that the path also includes the second operation stage, generating the sample data corresponding to the path by modifying a second feature value of a second process feature that is related to the second operation stage.

5. The method of claim 1, wherein the generating of the sample data by the first modifying of the at least portion of the reference data comprises generating the sample data using a sample generation machine learning model.

6. The method of claim 1, wherein the generating of the sample data comprises generating a respective sample data for each of the plurality of process features.

7. The method of claim 1, wherein the identifying of the attribution of the plurality of process features comprises:
calculating confidence of respective sample data corresponding to each of the process features based on the generated sample process result; and
identifying the attribution based on the calculated confidence.

8. The method of claim 1, wherein the identifying of the attribution of the plurality of process features comprises:
when the sample process result is generated using the first machine learning model, generating another sample process result using the second machine learning model;
when the sample process result is generated using the second machine learning model, generating the other sample process result using another second machine learning model, different from the second machine learning model, related to the first machine learning model;
calculating confidence of respective sample data corresponding to each of the process features based on the generated sample process result and the generated other sample process result; and
identifying the attribution based on the calculated confidence.

9. The method of claim 1, further comprising generating another sample process result using the first machine learning model provided second modified sample data, where the second modified sample data is obtained by performing a second modifying of the sample data that is different from the first modifying of the sample data,
wherein the identifying of the attribution of the plurality of process features comprises:
calculating a confidence of the sample data based on the sample process result and the other sample process result; and
calculating an attribution of a process feature based on the calculated confidence.

10. The method of claim 1,
wherein the generating of the process result comprises generating process results respectively using a plurality of different machine learning models provided the input data,
wherein the identifying of the attribution of the plurality of process features comprises:
respectively calculating attributions for a process feature, of the plurality of process features, based on the generated process results; and
identifying an attribution of the process feature based on the calculated attributions.

11. The method of claim 1, further comprising:
for first input data and second input data, respectively of the input data, comprising a same feature value for a target process feature, identifying a representative attribution, as the identified attribution, of the target process feature based on a sum of a first attribution of the target process feature, which is calculated based on the first input data, and a second attribution of the target process feature, which is calculated based on the second input data.

12. The method of claim 1, further comprising sorting at least one of the plurality of process features based on the identified attribution.

13. The method of claim 1, further comprising adjusting at least one of the plurality of process features based on the identified attribution.

14. A non-transitory computer-readable storage medium storing instructions that, when executed by a processor, cause the processor to perform the method of claim 1.

15. An electronic device, the electronic device comprising:
a processor configured to:
generate a process result using a first machine learning model provided input data, where the input data comprises feature values corresponding to a plurality of process features;
generate sample data by performance of a first modification of at least a portion of reference data based on dependency between two or more of the plurality of process features, where the reference data comprises feature values that are considered when a reference process result is generated; and
identify an attribution of the plurality of process features based on the generated process result and a sample process result generated using the first machine learning model, or a second machine learning model related to the first machine learning model, provided the generated sample data.

16. The device of claim 15, wherein, for the first modifying, the processor is further configured to:
modify a first feature value of a first process feature of the reference data; and
in response to a determination that a second process feature is dependent on the first process feature, select a second feature value of the second process feature from a candidate feature value that is dependent on the modified first feature value,
wherein the sample data is based on the modified first feature value and the selected second feature value.

17. The device of claim 15, wherein, for the first modifying, the processor is further configured to:
modify a first feature value of a first process feature, of the reference data, that is related to first equipment among pieces of the reference data; and
modify a second feature value of a second process feature, which is related to at least one of a chamber or a reticle that are dependent on the first equipment, to be another feature value indicating at least one of a corresponding chamber and a corresponding reticle allocated to another equipment indicated by the modified first feature value,
wherein the sample data is based on the modified first feature value and the modified second feature value.

18. The device of claim 15, wherein, for the first modifying, the processor is further configured to:
modify a first feature value of a first process feature, of the reference data, that is related to a first operation stage among pieces of the reference data; and
based on a result of a determination of whether a path, which includes the first operation stage, also includes a second operation stage being that the path also includes the second operation stage, generate the sample data corresponding to the path by modifying a second feature value of a second process feature that is related to the second operation stage.

19. The device of claim 15, wherein, for the identifying of the attribution, the processor is further configured to:
calculate confidence of respective sample data corresponding to each of the process features based on the generated sample process result; and
identify the attribution based on the calculated confidence.

20. The device of claim 15, wherein the processor is further configured to adjust at least one of the plurality of process features based on the identified attribution.
